(19) United States
(12) Patent Application Publication
(10) Pub. No.: US 2014/0335763 A1
(43) Pub. Date: Nov. 13, 2014

(54) POLISHING LIQUID COMPOSITION FOR MAGNETIC DISK SUBSTRATE

(71) Applicant: Kao Corporation, Tokyo (JP)

(72) Inventors: Yoshiaki OSHIMA, Wakayama-shi (JP); Takeshi HAMAGUCHI, Wakayama-shi (JP); Kanji SATO, Wakayama-shi (JP); Norihito YAMAGUCHI, Wakayama-shi (JP); Haruhiko DOI, Wakayama-shi (JP)

(21) Appl. No.: 14/446,156

(22) Filed: Jul. 29, 2014

Related U.S. Application Data
(62) Division of application No. 13/127,735, filed on May 5, 2011, now abandoned.

(30) Foreign Application Priority Data
Nov. 6, 2008 (JP) 2008-285828
Dec. 22, 2008 (JP) 2008-326364
Dec. 22, 2008 (JP) 2008-326365

(51) Int. Cl. C09G 1/02; B24B 29/00; C01B 33/14

(52) U.S. Cl. CPC C09G 1/02; C01B 33/14; B24B 29/00
USPC 451/36; 51/308; 252/79.1

(57) ABSTRACT

The present invention provides a polishing composition for a magnetic disk substrate that can reduce scratches and surface roughness of a polished substrate without impairing the productivity, and a method for manufacturing a magnetic disk substrate using the polishing composition. The polishing composition for a magnetic disk substrate includes colloidal silica having a ΔCV value of 0 to 10% and water. The ΔCV value is a difference (ΔCV=CV30−CV90) between a value (CV30) obtained by dividing a standard deviation based on a scattering intensity distribution at a detection angle of 30° according to a dynamic light scattering method by an average particle size based on the scattering intensity distribution and multiplying the result by 100 and a value (CV90) obtained by dividing a standard deviation based on a scattering intensity distribution at a detection angle of 90° according to the dynamic light scattering method by an average particle size based on the scattering intensity distribution and multiplying the result by 100.

### CROSS-REFERENCE TO RELATED APPLICATIONS

This application is a Divisional of co-pending application Ser. No. 13/127,735 filed on May 5, 2011, which is a National Phase of PCT International Application No. PCT/JP2009/068837 filed on Nov. 4, 2009, which claims priority under 35 U.S.C. §119(a) to Patent Application No. 2008-285828 filed in Japan on Nov. 6, 2008, Patent Application No. 2008-326364 filed in Japan on Dec. 22, 2008, and Patent Application No. 2008-326365 filed in Japan on Dec. 22, 2008. All of the above applications are hereby expressly incorporated by reference into the present application.

### TECHNICAL FIELD

The present invention relates to a polishing composition for a magnetic disk substrate and a method for manufacturing a magnetic disk substrate using the polishing composition.

### BACKGROUND ART

In recent years, a magnetic disk drive has become increasingly smaller in size and larger in capacity and is required to achieve higher recording density. To increase the recording density, the unit recording area should be reduced while the detection sensitivity of a weak magnetic signal should be improved. For this purpose, technological development for further reducing the flying height of a magnetic head has advanced. On the other hand, to ensure such a low flying height of the magnetic head and the recording area, a magnetic disk substrate is more and more strictly required to improve both smoothness and flatness (i.e., to reduce surface roughness, waviness, and edge rounding of the end side of the substrate) and to reduce defects (scratches, protrusions, pits, etc.). In order to meet these requirements, a polishing composition including colloidal silica as abrasive particles with a controlled particle size distribution, and a polishing composition including colloidal silica and an anionic polymer have been proposed (see, e.g., Patent Documents 1 to 6).

Patent Document 1 discloses a polishing composition that uses colloidal silica having a specific particle size distribution. In this polishing composition, the particle size of the colloidal silica is reduced and the particle size distribution is sharpened, thereby reducing the surface roughness of a substrate for a memory hard disk.

Patent Document 2 discloses a polishing composition for a glass substrate that includes a polymer having a sulfonic acid group. In this polishing composition, the addition of the polymer having the sulfonic acid group can reduce the surface roughness and contamination of the glass substrate.

Patent Document 3 discloses a polishing composition that includes colloidal silica (abrasive), polyacrylic acid ammonium salt (polishing resistance-reducing agent), EDTA-Fe salt (polishing accelerator), and water. This polishing composition can prevent damage to a chamfer portion caused by vibration during polishing, and also can reduce defects (scratches, pits, etc.).

Patent Document 4 discloses a polishing composition that includes spherical abrasive particles having a specific particle size distribution. This polishing composition uses the spherical particles and therefore can reduce the surface roughness or surface waviness of a magnetic disk substrate.

Patent Documents 5 and 6 disclose polishing compositions that include spinous silica fine particles. These polishing compositions use the spinous silica fine particles and therefore can improve the productivity (polishing rate) of a magnetic disk substrate.

### PRIOR ART DOCUMENTS

### Patent Documents

Patent Document 1: JP 2004-204151 A

Patent Document 2: JP 2006-167817 A

Patent Document 3: JP 2001-155332 A

Patent Document 4: JP 2008-93819 A

Patent Document 5: JP 2008-137822 A

Patent Document 6: JP 2008-169102 A

### DISCLOSURE OF INVENTION

### Problem to be Solved by the Invention

However, the conventional polishing compositions are not sufficient to achieve even larger capacity. For this purpose, scratches and the maximum value of surface roughness (AFM-Rmax) of a polished substrate need to be further reduced while maintaining the productivity (without reducing the polishing rate).

Moreover, the recording system of a magnetic disk has shifted from horizontal magnetic recording to perpendicular magnetic recording with an increase in capacity. In the manufacturing process of the magnetic disk for the perpendicular magnetic recording system, a texturing process is removed (which is necessary to align the magnetization direction in the horizontal magnetic recording system), and a magnetic layer is directly formed on the surface of the polished substrate. Therefore, the characteristics required for the surface quality of the substrate have become increasingly strict. The conventional polishing compositions cannot fully meet the requirements for scratches and the maximum value of surface roughness (AFM-Rmax) of the substrate for the perpendicular magnetic recording system.

The polishing composition of Patent Document 1 can reduce the surface roughness of a substrate, but cannot fully meet the requirements for scratches and the surface roughness of the substrate for the perpendicular magnetic recording system.

The polishing composition of Patent Document 4 can reduce the surface roughness of a substrate, but cannot achieve a proper polishing rate and therefore cannot satisfy the productivity.

The polishing compositions of Patent Documents 5 and 6 can improve the productivity, but cannot sufficiently reduce the surface roughness (particularly, the maximum height of the surface roughness: Rmax) or scratches of the substrate for the perpendicular magnetic recording system.

With the foregoing in mind, the present invention provides a polishing composition for a magnetic disk substrate that can reduce scratches and the maximum value of surface roughness (AFM-Rmax) of a polished substrate without impairing the productivity, and a method for manufacturing a magnetic disk substrate using the polishing composition.

### Means for Solving Problem

The present invention relates to a polishing composition for a magnetic disk substrate that includes colloidal silica and water. The colloidal silica has a ΔCV value of 0 to 10%, where the A CV value is a difference (ΔCV=CV30−CV90) between a value (CV30) obtained by dividing a standard deviation based on a scattering intensity distribution at a detection angle of 30° according to a dynamic light scattering method by an average particle size based on the scattering intensity distribution and multiplying the result by 100 and a value (CV90) obtained by dividing a standard deviation based on a scattering intensity distribution at a detection angle of 90° according to the dynamic light scattering method by an average particle size based on the scattering intensity distribution and multiplying the result by 100. The CV90 value of the colloidal silica is 1 to 35%. The average particle size of the colloidal silica based on the scattering intensity distribution at the detection angle of 90° according to the dynamic light scattering method is 1 to 40 nm.

Another aspect of the present invention relates to a method for manufacturing a magnetic disk substrate that includes polishing a substrate to be polished with the polishing composition for a magnetic disk substrate of the present invention.

### Effects of the Invention

The polishing composition for a magnetic disk substrate of the present invention preferably has the effect of being able to manufacture a magnetic disk substrate, particularly a magnetic disk substrate for the perpendicular magnetic recording system, in which scratches and the maximum value of surface roughness (AFM-Rmax) are reduced without significantly impairing the productivity and the surface roughness.

### DESCRIPTION OF THE INVENTION

The present invention is based on the knowledge that the use of specific colloidal silica in a polishing composition for a magnetic disk substrate can maintain the polishing rate at a level where the productivity is not impaired, reduce scratches and surface roughness of a polished substrate, and meet the demand for an increase in storage capacity.

Specifically, the present inventors found out that scratches of the polished substrate could be significantly reduced by controlling the colloidal silica with three parameters: an average particle size, which has been conventionally used; a value of coefficient of variation that indicates the spread of a particle size distribution (CV value); and a difference between the CV values at two different detection angles (ΔCV value).

In one aspect, the present invention relates to a polishing composition for a magnetic disk substrate (also referred to as a polishing composition of the present invention in the following) that includes colloidal silica and water. The colloidal silica has a ΔCV value of 0 to 10%, where the A CV value is a difference (ΔCV=CV30−CV90) between a value (CV30) obtained by dividing a standard deviation based on a scattering intensity distribution at a detection angle of 30° according to a dynamic light scattering method by an average particle size based on the scattering intensity distribution and multiplying the result by 100 and a value (CV90) obtained by dividing a standard deviation based on a scattering intensity distribution at a detection angle of 90° according to the dynamic light scattering method by an average particle size based on the scattering intensity distribution and multiplying the result by 100. The CV90 value of the colloidal silica is 1 to 35%. The average particle size of the colloidal silica measured at the detection angle of 90° according to the dynamic light scattering method is 1 to 40 nm.

Another aspect of the present invention is based on the knowledge that when the colloidal silica that meets the requirements for the three parameters (the average particle size, CV90, and ΔCV) is used with an anionic polymer (i.e., a water-soluble polymer having an anionic group), scratches and the maximum value of surface roughness (AFM-Rmax) of the polished substrate can be further reduced while maintaining the polishing rate during polishing. In another aspect, the present invention relates to a polishing composition for a magnetic disk substrate that includes colloidal silica, a water-soluble polymer having an anionic group, and water. The ΔCV value of the colloidal silica is 0 to 10%. The CV90 value of the colloidal silica is 1 to 35%. The average particle size of the colloidal silica based on the scattering intensity distribution at the detection angle of 90° according to the dynamic light scattering method is 1 to 40 nm. The addition of a small amount of the water-soluble polymer having the anionic group (preferably with a low molecular weight) may suppress the generation of silica aggregates during polishing and prevent the silica aggregates from coming out of the pores of a polishing pad by reducing frictional vibration during the polishing. Thus, it is assumed that scratches and the maximum value of surface roughness (AFM-Rmax) of the polished substrate are significantly reduced. However, the present invention is not limited to these assumed mechanisms.

Yet another aspect of the present invention is based on the knowledge that when the colloidal silica is controlled with attention to sphericity, surface roughness, and an average particle size (S2) measured by transmission electron microscope observation in addition to the ΔCV value, scratches and the surface roughness of the polished substrate can be further reduced. In yet another aspect, the present invention relates to a polishing composition for a magnetic disk substrate that includes colloidal silica and water. The colloidal silica meets all of the following requirements (a) to (c):

(a) the sphericity measured by transmission electron microscope observation is 0.75 to 1;

(b) the value of the surface roughness (SA1/SA2) calculated from a specific surface area (SA1) that is measured by a sodium titration method and a specific surface area (SA2) that is converted from the average particle size (S2) measured by transmission electron microscope observation is 1.3 or more; and

(c) the average particle size (S2) is 1 to 40 nm.

The polishing composition for a magnetic disk substrate of the present invention has the effect of being able to manufacture a magnetic disk substrate, particularly a magnetic disk substrate for the perpendicular magnetic recording system, in which scratches and the maximum value of surface roughness (AFM-Rmax) are reduced without impairing the productivity (i.e., without reducing the polishing rate).

[ΔCV Value]

In the present specification, the ΔCV value of the colloidal silica is a difference (ΔCV=CV30−CV90) between the value (CV30) of coefficient of variation (CV) and the value (CV90) of coefficient of variation (CV). The CV30 value is obtained by dividing a standard deviation of the particle size measured based on a scattering intensity distribution at a detection angle of 30° (forward scattering) according to a dynamic light scattering method by an average particle size measured based on the scattering intensity distribution at the detection angle of 30° according to the dynamic light scattering method and multiplying the result by 100. The CV90 value is obtained by dividing a standard deviation of the particle size measured based on a scattering intensity distribution at a detection angle of 90° (side scattering) according to the dynamic light scattering method by an average particle size measured based on the scattering intensity distribution at the detection angle of 90° according to the dynamic light scattering method and multiplying the result by 100. The ΔCV value represents the angular dependence of the scattering intensity distribution measured by the dynamic light scattering method. Specifically, the ΔCV value can be measured by the method as described in Examples.

The present inventors found out that there were correlations between the ΔCV value of the colloidal silica and the number of scratches and also between the ΔCV value of the colloidal silica and the amount of nonspherical silica. Although the mechanism for reducing scratches is not clear, it is assumed that silica aggregates (nonspherical silica) of 50 to 200 nm, which are formed by the aggregation of primary particles of the colloidal silica, are substances causing scratches, and that scratches are reduced because the amount of the aggregates is small.

In other words, although nonspherical particles have been difficult to detect, focusing attention on the ΔCV value can make it easy to detect the presence of the nonspherical particles in a particle dispersion sample. Therefore, the use of a polishing composition including such nonspherical particles can be avoided, resulting in a reduction in scratches.

In this case, whether the particles in the particle dispersion sample are spherical or nonspherical is generally determined by a method that uses the angular dependence of a diffusion coefficient (D=Γ/q²) measured by a dynamic scattering method as an index (see, e.g., JP H10(1998)-195152 A). Specifically, the average shape of the particles in the dispersion is considered to be closer to spherical as the angular dependence shown by a graph plotting Γ/q² against a scattering vector q² is smaller. On the other hand, the average shape of the particles in the dispersion is considered to be closer to nonspherical as the angular dependence is larger. In this conventional method that uses the angular dependence of the diffusion coefficient measured by the dynamic scattering method as an index, the shape or particle size of the particles are detected/measured, assuming that uniform particles are dispersed throughout the system. Therefore, it is difficult for the conventional method to detect the nonspherical particles present in a part of the dispersion sample that is mainly composed of spherical particles.

On the other hand, when a dispersion including spherical particles of 200 nm or less is measured by the dynamic light scattering method, the scattering intensity distribution is substantially constant regardless of the detection angle, so that the measurement results do not theoretically depend on the detection angle. However, in the case of a spherical particle dispersion including nonspherical particles, the scattering intensity distribution of dynamic light scattering of the dispersion significantly varies depending on the detection angle due to the presence of the nonspherical particles. That is, the lower the detection angle is, the broader the scattering intensity distribution becomes. Accordingly, the measurement results of the scattering intensity distribution of dynamic light scattering depend on the detection angle. Thus, it is conceivable that a few nonspherical particles present in the spherical particle dispersion can be measured by measuring the ΔCV value that is one of the indexes of “the angular dependence of the scattering intensity distribution measured by the dynamic light scattering method”. However, the present invention is not limited to these mechanisms.

[Scattering Intensity Distribution]

There are three particle size distributions (scattering intensity, volume conversion, and number conversion) of submicron particles obtained by the dynamic light scattering (DLS) method or a quasielastic light scattering (QLS) method. Among the three particle size distributions, the “scattering intensity distribution” in the present specification is the particle size distribution of scattering intensity. The submicron particles in a solvent generally continue the Brownian motion. Therefore, when these submicron particles are irradiated with a laser beam, the scattered light intensity changes (fluctuates) with time. An autocorrelation function of the fluctuations in the scattered light intensity is determined, e.g., by a photon correlation method (JIS Z 8826). Then, a diffusion coefficient (D) that indicates the velocity of the Brownian motion is calculated by the cumulant analysis. Moreover, an average particle size (d: hydrodynamic diameter) can be determined using the Einstein-Stokes equation. In addition to the polydispersity index (PI) of the cumulant method, the particle size distribution analysis may be, e.g., a histogram method (Marquardt method), an inverse Laplace transform method (CONTIN method), or a nonnegative least-squares method (NNLS method).

In the particle size distribution analysis by the dynamic light scatting method, the polydispersity index (PI) of the cumulant method is widely used in general. However, in the method for detecting a few nonspherical particles in the particle dispersion, it is preferable that an average particle size (d50) and a standard deviation are determined from the particle size distribution analysis by the histogram method (Marquardt method) or the inverse Laplace transform method (CONTIN method), a CV (coefficient of variation) value is calculated by dividing the standard deviation by the average particle size and multiplying the result by 100, and then the angular dependence (ΔCV value) is obtained.

### REFERENCE MATERIALS

A text of the 12th Scattering Workshop (Nov. 22, 2000): 1. Basic course in scattering “dynamic light scattering” (Mitsuhiro Shibayama, Professor at the University of Tokyo)

A text of the 20th Scattering Workshop (Dec. 4, 2008): 5. Measurement of particle size distribution of nanoparticles by dynamic light scattering (Yasushige Mori, Professor at Doshisha University)

[Angular Dependence of Scattering Intensity Distribution]

The “angular dependence of the scattering intensity distribution of a particle dispersion” in the present specification indicates the magnitude of a variation in the scattering intensity distribution with the scattering angle when the scattering intensity distribution of the particle dispersion is measured at different detection angles by the dynamic light scattering method. For example, if there is a large difference in the scattering intensity distribution between detection angles of 30° and 90°, the angular dependence of the scattering intensity distribution of the particle dispersion is considered to be large. Therefore, in the present specification, the measurement of the angular dependence of the scattering intensity distribution includes determining a difference (ΔCV value) between the measured values based on the scattering intensity distributions at two different detection angles.

To improve the detection accuracy of the nonspherical particles, the combination of two detection angles that is used to measure the angular dependence of the scattering intensity distribution is preferably a combination of forward scattering and side scattering or back scattering. From the same point of view, the detection angle of the forward scattering is preferably 0 to 80°, more preferably 0 to 60°, even more preferably 10 to 50°, and further preferably 20 to 40°. From the same point of view, the detection angle of the side scattering or the back scattering is preferably 80 to 180°, and more preferably 85 to 175°. In the present invention, two detection angles for determining the ΔCV value are 30° and 90°.

[Colloidal Silica]

The colloidal silica used for the polishing composition of the present invention may be obtained by a known production method in which colloidal silica is produced from a silicic acid aqueous solution. It is preferable that the silica particles are used in the form of a slurry for ease of handling.

In terms of improving the productivity and reducing scratches and the maximum value of surface roughness (AFM-Rmax) without impairing the productivity, the ΔCV value of the colloidal silica used in the present invention is 0 to 10%, preferably 0.01 to 10%, more preferably 0.01 to 7%, and even more preferably 0.1 to 5%.

In terms of reducing scratches and the maximum value of surface roughness (AFM-Rmax) without impairing the productivity, the CV90 value of the colloidal silica used in the present invention is 1 to 35%, preferably 5 to 34%, and more preferably 10 to 33%. In the present specification, as described above, the CV90 value is a value of coefficient of variation (CV) obtained by dividing a standard deviation of the particle size measured based on a scattering intensity distribution at a detection angle of 90° according to the dynamic light scattering method by an average particle size measured based on the scattering intensity distribution at the detection angle of 90° according to the dynamic light scattering method and multiplying the result by 100.

<Average Particle Size>

The “average particle size of the colloidal silica” in the present invention is the average particle size based on the scattering intensity distribution measured by the dynamic light scattering method, or the average particle size (S2) measured by transmission electron microscope observation. Unless otherwise noted, the “average particle size of the colloidal silica” is the average particle size based on the scattering intensity distribution measured at the detection angle of 90° by the dynamic light scattering method. Specifically, these average particle sizes can be determined by the methods as described in Examples.

In terms of reducing scratches and the maximum value of surface roughness (AFM-Rmax) without impairing the productivity, the average particle size (i.e., the average particle size based on the scattering intensity distribution measured by the dynamic light scattering method) of the colloidal silica used in the present invention is 1 to 40 nm, preferably 5 to 37 nm, and more preferably 10 to 35 nm. From the same point of view, the average particle size (S2) measured by transmission electron microscope observation is preferably 1 to 40 nm, more preferably 5 to 37 nm, and even more preferably 10 to 35 nm.

<Sphericity>

The sphericity of the colloidal silica measured by transmission electron microscope observation in the present specification is a ratio (A1/A2) of a projected area (A1) of a silica particle measured with a transmission electron microscope to an area (A2) of a circle having a circumference that is the same as the perimeter of the silica particle. The sphericity of the colloidal silica is preferably the average of the “A1/A2” ratios of 50 to 100 randomly selected colloidal silica particles in the polishing composition of the present invention. Specifically, the sphericity of the colloidal silica can be measured by the method as described in Examples. In terms of reducing scratches and the surface roughness without impairing the productivity, the sphericity of the colloidal silica used for the polishing composition of the present invention is preferably 0.75 to 1, more preferably 0.75 to 0.95, and even more preferably 0.75 to 0.85.

<Surface Roughness>

The surface roughness of the colloidal silica in the present specification is a ratio (SA1/SA2) of the specific surface area (SA1) that is measured by the sodium titration method to the specific surface area (SA2) that is converted from the average particle size (S2) measured by transmission electron microscope observation. Specifically, the surface roughness of the colloidal silica can be measured by the method as described in Examples. In this case, the specific surface area (SA1) measured by the sodium titration method is the specific surface area of the silica that is determined from the amount of consumption of a sodium hydroxide solution when the silica is titrated with the sodium hydroxide solution. Therefore, the specific surface area (SA1) is considered to reflect the actual surface area. Specifically, the specific surface area (SA1) increases with an increase in the number of asperities or wart-like projections on the silica surface. On the other hand, the specific surface area (SA2) calculated from the average particle size (S2) measured with a transmission electron microscope is determined, assuming that the silica is in the form of ideal spherical particles. Specifically, the specific surface area (SA2) decreases with an increase in the average particle size (S2). The specific surface area is a surface area per unit mass. If the silica is spherical in shape, the value of the surface roughness (SA1/SA2) increases as the wart-like projections on the silica surface increase, but decreases to 1 as the wart-like projections on the silica surface decrease and the silica surface becomes smoother. In terms of reducing scratches and the surface roughness without impairing the productivity, the surface roughness of the colloidal silica used for the polishing composition of the present invention is preferably 1.3 or more, more preferably 1.3 to 2.5, and even more preferably 1.3 to 2.0.

[Method for Adjusting ΔCV Value]

The ΔCV value of the colloidal silica is adjusted by the following methods that prevent the generation of silica aggregates (nonspherical silica) of 50 to 200 nm in the preparation of the polishing composition.

A) Filtration of the polishing composition

B) Process control during production of the colloidal silica

In the above A), the silica aggregates of 50 to 200 nm are removed, e.g., by centrifugal separation or microfiltration (JP 2006-102829 A and JP 2006-136996 A), so that the ΔCV value can be reduced. Specifically, the ΔCV value can be reduced by centrifuging a colloidal silica aqueous solution, which has been appropriately diluted at a silica concentration of 20 wt % or less, under the conditions that the 50 nm particles calculated using the Stokes equation can be removed (e.g., 10,000 G or more, a centrifuge tube with a height of about 10 cm, and 2 hours or more), or by filtering the colloidal silica aqueous solution under pressure through a membrane filter with a pore size of 0.05 μm or 0.1 μm (manufactured, e.g., by Advantec Toyo Kaisha, Ltd., Sumitomo 3M Limited, and Millipore).

The colloidal silica particles are generally produced in the following manner: 1) a mixed solution (seed liquid) containing less than 10 wt % of No. 3 sodium silicate and seed particles (silica having a small particle size) is placed in a reaction vessel and heated at 60° C. or more; 2) an active silicic acid aqueous solution obtained by bringing No. 3 sodium silicate into contact with a cation exchange resin and alkali (alkali metal or quaternary ammonium) are dropped into the mixed solution so as to make the pH constant and to grow spherical particles; and 3) the resultant mixture is aged and then concentrated by evaporation, ultrafiltration, or the like (see JP S47(1972)-1964 A, JP H1(1989)-23412 B, JP H4(1992)-55125 B, and JP H4(1992)-55127 B). However, there have been many reports that nonspherical particles also can be produced by slightly modifying the step in the same production process. For example, when polyvalent metal ions such as Ca and Mg are intentionally added because the active silica is very unstable, a silica sol containing long narrow particles can be produced. Moreover, nonspherical silica can be produced, e.g., by changing the following parameters: the temperature in the reaction vessel (if the temperature exceeds the boiling point of water, the water evaporates and the silica is dried at the gas-liquid interface); the pH in the reaction vessel (if the pH is 9 or less, the silica particles are likely to be connected); SiO₂/M₂O (M represents alkali metal or quaternary ammonium) in the reaction vessel; and the molar ratio (nonspherical silica is selectively produced at a molar ratio of 30 to 60) (see JP H8(1996)-5657 B, Japanese Patent No. 2803134, JP 2006-80406 A, and JP 2007-153671 A). Therefore, in the above B), the process control is performed to avoid the conditions under which nonspherical silica is locally generated in the known production process of spherical colloidal silica, so that the ΔCV value can be adjusted to be small.

A method for adjusting the particle size distribution of the colloidal silica is not particularly limited. For example, a desired particle size distribution can be provided by adding particles that serve as new nuclei for the growth of the particles during production of the colloidal silica, or by mixing two or more types of silica particles having different particle size distributions.

In terms of improving the polishing rate, the content of the colloidal silica particles in the polishing composition of the present invention is preferably 0.5 wt % or more, more preferably 1 wt % or more, even more preferably 3 wt % or more, and further preferably 4 wt % or more. In terms of improving the flatness of the substrate surface further, the content of the colloidal silica particles is preferably 20 wt % or less, more preferably 15 wt % or less, even more preferably 13 wt % or less, and further preferably 10 wt % or less. That is, the content of the colloidal silica particles is preferably 0.5 to 20 wt %, more preferably 1 to 15 wt %, even more preferably 3 to 13 wt %, and further preferably 4 to 10 wt %.

[Water-Soluble Polymer Having Anionic Group]

In terms of reducing scratches and the maximum value of surface roughness (AFM-Rmax) of the polished substrate, the polishing composition of the present invention preferably includes a water-soluble polymer having an anionic group (also referred to as an anionic water-soluble polymer in the following). The anionic water-soluble polymer may prevent the silica aggregates from coming out of the pores of a polishing pad by reducing frictional vibration during polishing, and thus it is assumed that scratches and the maximum value of surface roughness (AFM-Rmax) of the polished substrate are reduced.

The anionic group of the anionic water-soluble polymer may be, e.g., a carboxylic acid group, a sulfonic acid group, a sulfuric ester group, a phosphoric ester group, or a phosphonic acid group. Among them, the water-soluble polymer having the carboxylic acid group and/or the sulfonic acid group is more preferred so as to reduce scratches. These anionic groups may be in the form of a neutralized salt.

The water-soluble polymer having the carboxylic acid group and/or the sulfonic acid group may be a (co)polymer or its salt having at least one constitutional unit selected from the group consisting of a constitutional unit derived from a monomer having the carboxylic acid group and a constitutional unit derived from a monomer having the sulfonic acid group. Examples of the monomer having the carboxylic acid group include itaconic acid, (meth)acrylic acid, and maleic acid.

Examples of the monomer having the sulfonic acid group include isoprenesulfonic acid, 2-(meth)acrylamide-2-methylpropanesulfonic acid, styrenesulfonic acid, methallylsulfonic acid, vinylsufonic acid, allylsulfonic acid, isoamylenesulfonic acid, and naphthalenesulfonic acid. The anionic water-soluble polymer may include two or more types of constitutional units derived from the monomer having the carboxylic acid group and two or more types of constitutional units derived from the monomer having the sulfonic acid group.

In particular, the anionic water-soluble polymer is preferably a polymer having a constitutional unit expressed by the following general formula (1) in terms of reducing scratches and the maximum value of surface roughness (AFM-Rmax) of the polished substrate without impairing the productivity.

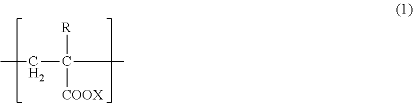

In the general formula (1), R is a hydrogen atom, a methyl group, or an ethyl group and X is a hydrogen atom, an alkali metal atom, an alkaline-earth metal atom (½ atom), an ammonium group, or an organic ammonium group.

The (meth)acrylic acid-based (co)polymer and its salt having the constitutional unit expressed by the general formula (1) are preferably a (meth)acrylic acid/sulfonic acid copolymer, a (meth)acrylic acid/maleic acid copolymer, poly(meth)acrylic acid, and salts thereof, and more preferably the (meth)acrylic acid/sulfonic acid copolymer, the poly(meth)acrylic acid, and salts thereof. The anionic water-soluble polymer may include one or more than one type of these (co)polymers. In the present invention, the (meth)acrylic acid indicates acrylic acid or methacrylic acid.

The (meth)acrylic acid/sulfonic acid copolymer is a copolymer including a constitutional unit derived from the (meth)acrylic acid and a constitutional unit derived from the monomer containing the sulfonic acid group. The (meth)acrylic acid/sulfonic acid copolymer may include two or more types of constitutional units derived from the monomer containing the sulfonic acid group.

In terms of reducing scratches, the monomer containing the sulfonic acid group is preferably the isoprenesulfonic acid and the 2-(meth)acrylamide-2-methylpropanesulfonic acid, and more preferably the 2-(meth)acrylamide-2-methylpropanesulfonic acid. In the present invention, the 2-(meth)acrylamide-2-methylpropanesulfonic acid indicates 2-acrylamide-2-methylpropanesulfonic acid or 2-methacrylamide-2-methylpropanesulfonic acid.

The (meth)acrylic acid/sulfonic acid copolymer may include a constitutional unit derived from a monomer other than the monomer containing the sulfonic acid group and the (meth)acrylic acid monomer as long as the effect of the present invention is obtained.

In terms of reducing scratches, the content of the constitutional unit derived from the monomer containing the sulfonic acid group with respect to all the constitutional units of the (meth)acrylic acid/sulfonic acid copolymer or its salt may be 10 to 90 mol %, 15 to 80 mol %, or 15 to 50 mol % and is preferably 3 to 97 mol %, more preferably 50 to 95 mol %, and even more preferably 70 to 90 mol %. In this case, the (meth)acrylic acid monomer containing the sulfonic acid group is counted as the monomer containing the sulfonic acid group.

In terms of reducing scratches, the preferred examples of the (meth)acrylic acid/sulfonic acid copolymer include a (meth)acrylic acid/isoprenesulfonic acid copolymer, a (meth)acrylic acid/2-(meth)acrylamide-2-methylpropanesulfonic acid copolymer, and a (meth)acrylic acid/isoprenesulfonic acid/2-(meth)acrylamide-2-methylpropanesulfonic acid copolymer.

The (meth)acrylic acid/maleic acid copolymer is a copolymer including a constitutional unit derived from the (meth)acrylic acid and a constitutional unit derived from the maleic acid.

The (meth)acrylic acid/maleic acid copolymer may include a constitutional unit derived from a monomer other than the maleic acid monomer and the (meth)acrylic acid monomer as long as the effect of the present invention is obtained.

In terms of reducing nanoscratches, the content of the constitutional unit derived from the maleic acid with respect to all the constitutional units of the (meth)acrylic acid/maleic acid copolymer may be 10 to 90 mol %, 20 to 80 mol %, or 30 to 70 mol % and is preferably 5 to 95 mol %, more preferably 50 to 95 mol %, and even more preferably 70 to 90 mol %.

The above (co)polymer can be produced, e.g., from a base polymer having a diene structure or an aromatic structure with a known method as described, e.g., in New Experimental Chemistry Course 14 (Synthesis and Reaction of Organic Compounds III, page 1773, 1978) edited by the Chemical Society of Japan.

Moreover, the water-soluble polymer having the carboxylic acid group and/or the sulfonic acid group is also preferably a polymer having a constitutional unit expressed by the following general formula (2).

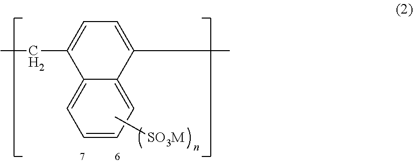

In terms of reducing scratches and improving the polishing rate, the proportion of the constitutional unit expressed by the general formula (2) to all the constitutional units of the polymer is preferably more than 50 mol %, more preferably 70 mol % or more, even more preferably 90 mol % or more, and further preferably 97 mol % or more. It is particularly preferable that the polymer has only a repeating structure of the constitutional units expressed by the general formula (2). Moreover, it is preferable that the molecular end of the polymer is sealed with hydrogen.

In the general formula (2), M is a hydrogen atom, an alkali metal atom, an alkaline-earth metal atom (½ atom), an ammonium group, or an organic ammonium group. The alkali metal is preferably sodium and potassium. In the general formula (2), n is 1 or 2, and preferably 1 so as to reduce scratches. As the whole “polymer mainly including the constitutional unit expressed by the general formula (2)”, the average of n is preferably 0.5 to 1.5. Moreover, in the general formula (2), the sulfonic acid group (—SO₃M) may be bonded to any position of the naphthylene group, but preferably to the 6-position or 7-position, and particularly preferably to the 6-position so as to reduce scratches. In the present specification, the 6-position and the 7-position of the naphthylene group are shown in the general formula (2).

The polymer having the constitutional unit expressed by the general formula (2) can be synthesized by a known method that includes, e.g., introducing a sulfonic acid group into a naphthalene monomer using a sulfonating agent such as concentrated sulfuric acid, adding water and formalin water for condensation, and neutralizing the sulfonic acid group with an inorganic salt such as Ca(OH)₂ or Na₂SO₄. As the polymer mainly including the constitutional unit expressed by the general formula (2), commercially available products (e.g., DEMOL N (trade name) and MIGHTY 150 (trade name) manufactured by Kao Corporation) also can be used. Documents (JP H9(1997)-279127 A, JP H11(1999)-188614 A, and JP 2008-227098) can be referred to for information about the polymer having the constitutional unit expressed by the general formula (2).

The anionic water-soluble polymer may include constitutional units other than those described above. Examples of the monomers that can be used as the other constitutional units include the following: aromatic vinyl compounds such as styrene, α-methyl styrene, vinyltoluene, and p-methyl styrene; (meth)acrylic acid alkyl esters such as methyl (meth)acrylate, ethyl (meth)acrylate, and octyl (meth)acrylate; aliphatic conjugated dienes such as butadiene, isoprene, 2-chlor-1,3-butadiene, and 1-chlor-1,3-butadiene; vinyl cyanide compounds such as (meth)acrylonitrile; and phosphoric acid compounds. These monomers can be used individually or in combinations of two or more. In terms of reducing scratches, the water-soluble polymer having the other constitutional units and the carboxylic acid group and/or the sulfonic acid group is preferably a styrene/isoprenesulfonic acid copolymer.

The counter ions of the water-soluble polymer having the anionic group are not particularly limited, and specifically may be ions of metals, ammonium, alkylammonium, etc. Specific examples of the metals include the metals belonging to Group 1A, 1B, 2A, 2B, 3A, 3B, 4A, 6A, 7A or 8 of the periodic table (long-period form). Among these metals, the metals of Group 1A, 3B, or 8 are preferred, and sodium and potassium of Group 1A are more preferred so as to reduce the surface roughness and nanoscratches. Specific examples of the alkylammonium include tetramethylammonium, tetraethylammonium, and tetrabutylammonium. Among these salts, ammonium salt, sodium salt, and potassium salt are more preferred.

In terms of reducing scratches and maintaining the productivity, the weight-average molecular weight of the anionic water-soluble polymer is preferably 500 to 100000, more preferably 500 to 50000, even more preferably 500 to 20000, further preferably 1000 to 10000, and particularly preferably 1500 to 5000. Specifically, the weight-average molecular weight can be measured by the method as described in Examples.

In terms of reducing scratches and maintaining the productivity, the content of the anionic water-soluble polymer in the polishing composition is preferably 0.001 to 1 wt %, more preferably 0.005 to 0.5 wt %, even more preferably 0.01 to 0.2 wt %, further preferably 0.01 to 0.1 wt %, and particularly preferably 0.01 to 0.075 wt %.

In terms of improving the polishing rate and reducing the surface roughness and scratches, the concentration ratio of the colloidal silica to the anionic water-soluble polymer (silica concentration (wt %)/anionic water-soluble polymer concentration (wt %)) in the polishing composition is preferably 5 to 5000, more preferably 10 to 1000, and even more preferably 25 to 500.

[Water]

The water included in the polishing composition of the present invention is used as a medium, and may be distilled water, ion-exchanged water, or ultrapure water. In terms of the surface cleaning of a substrate to be polished, the ion-exchanged water and the ultrapure water are preferred, and the ultrapure water is more preferred. The content of water in the polishing composition is preferably 60 to 99.4 wt %, and more preferably 70 to 98.9 wt %. Moreover, an organic solvent such as alcohol may be blended to the extent that it does not inhibit the effect of the present invention.

[Acid]

The polishing composition of the present invention preferably includes an acid and/or its salt. In terms of improving the polishing rate, the acid used for the polishing composition of the present invention is preferably a compound with a pK1 of 2 or less. In terms of reducing scratches, a suitable compound preferably has a pK1 of 1.5 or less, more preferably has a pK1 of 1 or less, and even more preferably is highly acidic such that it cannot be expressed by pK1. Preferred examples of the acid include the following: inorganic acids such as nitric acid, sulfuric acid, sulfurous acid, persulfuric acid, hydrochloric acid, perchloric acid, phosphoric acid, phosphonic acid, phosphinic acid, pyrophosphoric acid, tripolyphosphoric acid, and amidosulfonic acid; organic phosphonic acids such as 2-aminoethylphosphonic acid, 1-hydroxyethylidene-1,1-diphosphonic acid, aminotri(methylenephosphonic acid), ethylenediaminetetra(methylenephosphonic acid), diethylenetriaminepenta(methylenephosphonic acid), ethane-1,1-diphosphonic acid, ethane-1,1,2-triphosphonic acid, ethane-1-hydroxy-1,1-diphosphonic acid, ethane-1-hydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, and α-methylphosphonosuccinic acid; aminocarboxylic acids such as glutamic acid, picolinic acid, and aspartic acid; and carboxylic acids such as citric acid, tartaric acid, oxalic acid, nitroacetic acid, maleic acid, and oxaloacetic acid. Above all, the inorganic acids, the carboxylic acids, and the organic phosphonic acids are preferred so as to reduce scratches. Among the inorganic acids, the phosphoric acid, the nitric acid, the sulfuric acid, the hydrochloric acid, and the perchloric acid are more preferred, and the phosphoric acid and the sulfuric acid are even more preferred. Among the carboxylic acids, the citric acid, the tartaric acid, and the maleic acid are more preferred, and the citric acid is even more preferred. Among the organic phosphonic acids, the 1-hydroxyethylidene-1,1-diphosphonic acid, the aminotri(methylenephosphonic acid), the ethylenediaminetetra(methylenephosphonic acid), and the diethylenetriaminepenta(methylenephosphonic acid) are more preferred, and the 1-hydroxyethylidene-1,1-diphosphonic acid and the aminotri(methylenephosphonic acid) are even more preferred. These acids and their salts may be used individually or in combinations of two or more. In terms of improving the polishing rate, reducing nanoprotrusions, and improving the surface cleaning of the substrate, mixing of two or more acids and their salts is preferred, and mixing of two or more acids selected from the group consisting of the phosphoric acid, the sulfuric acid, the citric acid, and the 1-hydroxyethylidene-1,1-diphosphonic acid is more preferred. In the present specification, pK1 indicates the logarithm of the reciprocal of a first acid dissociation constant (25° C.) for organic or inorganic compounds. The pK1 of each compound is described, e.g., in “Handbook of Chemistry (Basic) II”, 4th ed., the Chemical Society of Japan, pp. 316-325.

The salts of the above acids are not particularly limited, and specifically may be ions of metals, ammonium, alkylammonium, etc. Specific examples of the metals include the metals belonging to Group 1A, 1B, 2A, 2B, 3A, 3B, 4A, 6A, 7A or 8 of the periodic table (long-period form). Among them, the salts of the acids with the metals of Group 1A or ammonium are preferred so as to reduce scratches.

In terms of improving the polishing rate and reducing the surface roughness and scratches, the content of the acid and its salt in the polishing composition is preferably 0.001 to 5 wt %, more preferably 0.01 to 4 wt %, even more preferably 0.05 to 3 wt %, and further preferably 0.1 to 2.0 wt %.

[Oxidizing Agent]

The polishing composition of the present invention preferably includes an oxidizing agent. In terms of improving the polishing rate, examples of the oxidizing agent that can be used for the polishing composition of the present invention include peroxide, permanganic acid or its salt, chromic acid or its salt, peroxoacid or its salt, oxyacid or its salt, metal salts, nitric acids, and sulfuric acids.

The peroxide may be, e.g., hydrogen peroxide, sodium peroxide, or barium peroxide. The permanganic acid or its salt may be, e.g., potassium permanganate. The chromic acid or its salt may be, e.g., a metal salt of chromic acid or a metal salt of dichromic acid. The peroxo acid or its salt may be, e.g., peroxodisulfuric acid, ammonium peroxodisulfate, a metal salt of peroxodisulfuric acid, peroxophosphoric acid, peroxosulfuric acid, sodium peroxoborate, performic acid, peracetic acid, perbenzoic acid, or perphthalic acid. The oxyacid or its salt may be, e.g., hypochlorous acid, hypobromous acid, hypoiodous acid, chloric acid, bromic acid, iodic acid, sodium hypochlorite, or calcium hypochlorite. The metal salts may be, e.g., iron (III) chloride, iron (III) sulfate, iron (III) nitrate, iron (III) citrate, and ammonium iron (III) sulfate.

As a suitable oxidizing agent, the hydrogen peroxide, the iron (III) nitrate, the peracetic acid, the ammonium peroxodisulfate, the iron (III) sulfate, the ammonium iron (III) sulfate, or the like may be used. As a more suitable oxidizing agent, the hydrogen peroxide may be used, since it is widely available and inexpensive, and also can prevent adhesion of a metal ion to the surface. These oxidizing agents may be used individually or in combinations of two or more.

In terms of improving the polishing rate, the content of the oxidizing agent in the polishing composition is preferably 0.01 wt % or more, more preferably 0.05 wt % or more, and even more preferably 0.1 wt % or more. In terms of reducing the surface roughness, the waviness, and scratches, the content of the oxidizing agent is preferably 4 wt % or less, more preferably 2 wt % or less, and even more preferably 1 wt % or less. Therefore, to improve the polishing rate while maintaining the surface quality, the content of the oxidizing agent is preferably 0.01 to 4 wt %, more preferably 0.05 to 2 wt %, and even more preferably 0.1 to 1 wt %.

[Other Components]

The polishing composition of the present invention may include other components such as a thickening agent, a dispersing agent, an anticorrosive agent, basic substances, and a surface-active agent as needed. The content of the other optional components in the polishing composition is preferably 0 to 10 wt %, and more preferably 0 to 5 wt %.

[pH of Polishing Composition]

In terms of improving the polishing rate, the pH of the polishing composition of the present invention is preferably 3.0 or less, more preferably 2.5 or less, even more preferably 2.0 or less, and further preferably 1.8 or less. In terms of reducing the surface roughness, the pH of the polishing composition is preferably 0.5 or more, more preferably 0.8 or more, even more preferably 1.0 or more, and further preferably 1.2 or more. In terms of improving the polishing rate, the liquid waste pH of the polishing composition is preferably 3 or less, more preferably 2.5 or less, even more preferably 2.2 or less, and further preferably 2.0 or less. In terms of reducing the surface roughness, the liquid waste pH is preferably 0.8 or more, more preferably 1.0 or more, even more preferably 1.2 or more, and further preferably 1.5 or more. The liquid waste pH indicates the pH of the polishing wastes in the polishing process using the polishing composition, i.e., the pH of the polishing composition immediately after being discharged from a polishing machine

[Method for Preparing Polishing Composition]

The polishing composition of the present invention can be prepared, e.g., by mixing water and the colloidal silica and optionally the anionic water-soluble polymer, the acid and/or its salt, the oxidizing agent, and the other components with a known method. In this case, the colloidal silica may be mixed either in the form of condensed slurry or after being diluted in water or the like. The content and concentration of each component in the polishing composition of the present invention fall in the ranges as described above. However, in another aspect, the polishing composition of the present invention may be prepared in the form of a concentrated composition.

Another aspect of the present invention relates to a method for preparing a polishing composition for a magnetic disk substrate that includes colloidal silica. The method for preparing the polishing composition for a magnetic disk substrate includes selecting and/or confirming and then using the colloidal silica in which the average particle size measured at a detection angle of 90° according to the dynamic light scattering method is 1 to 40 nm, the CV value (CV90) obtained by dividing a standard deviation measured at the detection angle of 90° according to the dynamic light scattering method by the average particle size and multiplying the result by 100 is 1 to 35%, and a difference (ΔCV=CV30−CV90) between the CV value (CV30) obtained by dividing a standard deviation measured at a detection angle of 30° according to the dynamic light scattering method by the average particle size and multiplying the result by 100 and the CV90 value is 0 to 10%. The polishing composition for a magnetic disk substrate that includes the above colloidal silica can reduce scratches after polishing. Obviously, this method for preparing the polishing composition for a magnetic disk substrate can be used to produce the polishing composition of the present invention.

[Method for Manufacturing Magnetic Disk Substrate]

Another aspect of the present invention relates to a method for manufacturing a magnetic disk substrate (also referred to as the manufacturing method of the present invention in the following). The method for manufacturing a magnetic disk substrate of the present invention includes polishing a substrate to be polished with the polishing composition of the present invention (also referred to as a “polishing process using the polishing composition of the present invention” in the following). This method can suppress a reduction in polishing rate and can preferably provide a magnetic disk substrate in which scratches after polishing are reduced without significantly impairing the productivity and the surface roughness of the polished substrate. The manufacturing method of the present invention is particularly suitable for the manufacture of a magnetic disk substrate for the perpendicular magnetic recording system. Thus, in another aspect, the manufacturing method of the present invention is a method for manufacturing a magnetic disk substrate for the perpendicular magnetic recording system that includes the polishing process using the polishing composition of the present invention.

For example, the process of polishing the substrate to be polished with the polishing composition of the present invention may include the following: sandwiching the substrate to be polished between surface plates to which a polishing pad such as a nonwoven organic polymer polishing cloth is attached; supplying the polishing composition to a polishing machine; and polishing the substrate to be polished by moving the surface plates and the substrate.

When the polishing process of the substrate to be polished includes multiple stages, the polishing process using the polishing composition of the present invention is performed preferably in any of the second and subsequent stages, and more preferably in the final polishing process. In such a case, to avoid the abrasive material or polishing composition of the previous stage entering, different polishing machines may be used in each stage. When using the different polishing machines, it is preferable that the substrate to be polished is cleaned after each polishing process. The polishing composition of the present invention also can be used in circular polishing that recycles the used polishing liquid. The polishing machine is not particularly limited, and a known polishing machine for polishing a magnetic disk substrate can be used

In an embodiment, the manufacturing method of the present invention may include selecting and/or confirming and then using the polishing composition that includes the colloidal silica in which the average particle size measured at a detection angle of 90° according to the dynamic light scattering method is 1 to 40 nm, the CV value (CV90) of the average particle size measured at the detection angle of 90° according to the dynamic light scattering method is 1 to 35%, and a difference (ΔCV=CV30−CV90) between the CV value (CV30) obtained by dividing a standard deviation measured at a detection angle of 30° according to the dynamic light scattering method by the average particle size and multiplying the result by 100 and the CV90 value is 0 to 10%. Obviously, the polishing composition including the above colloidal silica includes the polishing composition of the present invention.

[Polishing Pad]

The polishing pad used in the present invention is not particularly limited, and may be a suede type, a nonwoven fabric type, a polyurethane closed-cell foam type, or a two-layer type in which these materials are laminated. In terms of the polishing rate, the suede type polishing pad is preferred.

In terms of reducing scratches and ensuring the pad life, the average pore diameter of the surface member of the polishing pad is preferably 50 μm or less, more preferably 45 μm or less, even more preferably 40 μm or less, and further preferably 35 μm or less. In terms of the polishing liquid retention capacity of the pad, the average pore diameter is preferably 0.01 μm or more, more preferably 0.1 μm or more, even more preferably 1 μm or more, and further preferably 10 μm or more so as to retain the polishing liquid in the pores and prevent a lack of the polishing liquid. In terms of maintaining the polishing rate, the maximum value of the pore diameter of the polishing pad is preferably 100 μm or less, more preferably 70 μm or less, even more preferably 60 μm or less, and particularly preferably 50 μm or less. In another aspect, the manufacturing method of the present invention uses the polishing pad having a surface member with an average pore diameter of 10 to 50 μm in the polishing process using the polishing composition of the present invention.

[Polishing Pressure]

In the polishing process using the polishing composition of the present invention, the polishing pressure is preferably 5.9 kPa or more, more preferably 6.9 kPa or more, and even more preferably 7.5 kPa or more. This can suppress a reduction in polishing rate and thus can improve the productivity. The polishing pressure in the manufacturing method of the present invention indicates the pressure of a surface plate applied to the polishing surface of the substrate to be polished during polishing. In the polishing process using the polishing composition of the present invention, the polishing pressure is preferably 20 kPa or less, more preferably 18 kPa or less, and even more preferably 16 kPa or less. This can suppress the formation of scratches. Accordingly, the polishing pressure in the polishing process using the polishing composition of the present invention is preferably 5.9 to 20 kPa, more preferably 6.9 to 18 kPa, and even more preferably 7.5 to 16 kPa. The polishing pressure can be adjusted by applying an air pressure or weight on at least one of the surface plate and the substrate to be polished.

[Supply of Polishing Composition]

In terms of reducing scratches, the supply rate of the polishing composition in the polishing process using the polishing composition of the present invention is preferably 0.05 to 15 mL/min, more preferably 0.06 to 10 mL/min, even more preferably 0.07 to 1 mL/min, further preferably 0.08 to 0.5 mL/min, and still further preferably 0.12 to 0.5 mL/min per 1 cm² of the substrate to be polished.

The polishing composition of the present invention may be continuously supplied to a polishing machine by using a pump or the like. Moreover, the polishing composition may be supplied to a polishing machine as a single solution containing all the components. Alternatively, in view of the stability or the like of the polishing composition, it may be divided into a plurality of component solutions, and two or more component solutions may be supplied. In the latter case, the plurality of component solutions are mixed, e.g., in a supply pipe or on the substrate to be polished, thereby forming the polishing composition of the present invention.

[Substrate to be Polished]

The materials for the substrate to be polished that is suitably used in the present invention may include, e.g., metals or metalloids such as silicon, aluminum, nickel, tungsten, copper, tantalum, and titanium, alloys of these metals, glassy substances such as glass, glassy carbon, and amorphous carbon, ceramic materials such as alumina, silicon dioxide, silicon nitride, tantalum nitride, and titanium carbide, and resins such as a polyimide resin. Among them, the substrate to be polished including metals such as aluminum, nickel, tungsten, and copper or alloys that contain these metals as the main component is preferred. In particular, a Ni—P plated aluminum alloy substrate and a glass substrate such as crystallized glass or tempered glass are preferred, and especially the Ni—P plated aluminum alloy substrate is preferred.

The present invention can provide a magnetic disk substrate in which scratches and the maximum value of surface roughness (AFM-Rmax) are highly reduced after polishing without impairing the productivity, and thus is suitable for the polishing of a magnetic disk substrate for the perpendicular magnetic recording system that requires enhanced surface smoothness.

The shape of the substrate to be polished is not particularly limited, and a shape with a flat portion such as a disk, plate, slab, or prism and a shape with a curved portion such as a lens may be used. In particular, a disk-shaped substrate is suitable. When the substrate to be polished has a disk shape, the outer diameter is, e.g., about 2 to 95 mm and the thickness is, e.g., about 0.5 to 2 mm

[Polishing Method]

Another aspect of the present invention relates to a method for polishing a substrate to be polished that includes polishing the substrate to be polished while bringing the polishing composition into contact with the polishing pad. The polishing method of the present invention allows the substrate to be polished without impairing the productivity and can preferably provide a magnetic disk substrate, particularly a magnetic disk substrate for the perpendicular magnetic recording system, in which both the surface roughness and scratches are reduced. As described above, the substrate to be polished by the polishing method of the present invention may be used for the manufacture of a magnetic disk substrate or a substrate for a magnetic recording medium. In particular, the substrate to be polished is preferably used for the manufacture of a magnetic disk substrate for the perpendicular magnetic recording system. The specific polishing method and conditions can be performed as described above.

The present invention can provide a magnetic disk substrate in which the surface roughness is reduced without impairing the productivity. In particular, the maximum height Rmax of the surface roughness measured by observing the surface of the magnetic disk substrate with an atomic force microscope (AFM) can be improved, e.g., to less than 3 nm, preferably less than 2 nm, more preferably less than 1.5 nm. In particular, the present invention can preferably provide a magnetic disk substrate for the perpendicular magnetic recording system.

### Examples

### Examples 1-1 to 1-16, Comparative Examples 1-1 to 1-14

Polishing compositions (Examples 1-1 to 1-16 and Comparative Examples 1-1 to 1-14) were prepared using colloidal silica and optionally the anionic water-soluble polymers shown in Table 1. Then, substrates to be polished were polished with the polishing compositions, and scratches and surface roughness of each of the polished substrates were evaluated. Table 2 shows the evaluation results. The preparation method of the polishing compositions, the measuring method of each parameter, the polishing conditions (polishing method), and the evaluation method were as follows.

[Preparation Method of Polishing Composition]

The colloidal silica (A to G, K to Q, and T manufactured by JGC Catalysts and Chemicals Ltd., H to J and S manufactured by DuPont Air Products Nanomaterials L.L.C., and R manufactured by NISSAN CHEMICAL INDUSTRIES, LTD.), the anionic water-soluble polymers shown in Table 1, a sulfuric acid (special grade chemicals manufactured by Wako Pure Chemical Industries, Ltd.), HEDP (1-hydroxyethylidene-1,1-diphosphonic acid, “DEQUEST 2010” manufactured by Solutia Japan Limited), and a hydrogen peroxide solution (with a concentration of 35 wt %, manufactured by Adeka Corporation) were added to ion-exchanged water and mixed to prepare the polishing compositions of Examples 1-1 to 1-16 and Comparative Examples 1-1 to 1-14, each of which included the colloidal silica and optionally the anionic water-soluble polymer, as shown in Table 2. The contents of the sulfuric acid, the HEDP, and the hydrogen peroxide in the polishing compositions were 0.4 wt %, 0.1 wt %, and 0.4 wt %, respectively.

[Measuring Method of Average Particle Size, CV Value, and ΔCV Value of Colloidal Silica]

<Average Particle Size and CV Value>

The above colloidal silica, the sulfuric acid, the HEDP, and the hydrogen peroxide solution were added to the ion-exchanged water and mixed to prepare reference samples. The contents of the colloidal silica, the sulfuric acid, the HEDP, and the hydrogen peroxide in the reference samples were 5 wt %, 0.4 wt %, 0.1 wt %, and 0.4 wt %, respectively. Each of the reference samples was integrated 200 times using a dynamic light scattering device DLS-6500 (manufactured by Otsuka Electronics Co., Ltd.) in accordance with the manufacturer's instruction manual. Then, a scatting intensity distribution at a detection angle of 90° was obtained by the cumulant method, and the particle size was determined when the area of the scattering intensity distribution thus obtained was 50% of the total area. This particle size was defined as an average particle size of the colloidal silica. Moreover, a CV value was obtained by dividing a standard deviation based on the scattering intensity distribution according to the above measuring method by the average particle size and multiplying the result by 100.

<ΔCV Value>

A ΔCV value was obtained by subtracting the CV value (CV90) of the colloidal silica particles at the detection angle of 90° from a CV value (CV30) of the colloidal silica particles at a detection angle of 30° measured according to the above measuring method.

(Measurement Conditions of DLS-6500)

Detection angle: 90°

Sampling time: 4 (μm)

Correlation channel: 256 (ch)

Correlation method: TI

Sampling temperature: 26.0 (° C.)

Detection angle: 30°

Sampling time: 10 (μm)

Correlation channel: 1024 (ch)

Correlation method: TI

Sampling temperature: 26.0 (° C.)

[Measuring Method of Weight-Average Molecular Weight of Polymer]

<Weight-Average Molecular Weight of Polymer Having Carboxylic Acid Group>

The weight-average molecular weight of a copolymer having a carboxylic acid group was measured by a gel permeation chromatography (GPC) under the following conditions.

(GPC Conditions)

Column: G4000 PWXL (manufactured by TOSOH CORPORATION)+G2500 PWXL (manufactured by TOSOH CORPORATION)

Eluant: 0.2 M phosphate buffer/acetonitrile=9/1 (capacity ratio)

Flow rate: 10 mL/min

Temperature: 40° C.

Detection: 210 nm

Sample: concentration 5 mg/mL (injection volume 100 μL)

Polymer for calibration curve: polyacrylic acids with molecular weights (Mp) of 115000, 28000, 4100, and 1250 (manufactured by Sowa Science Corporation and American Polymer Standards Corporation)

<Weight-Average Molecular Weight of Styrene/Isoprenesulfonic Acid Copolymer>

The weight-average molecular weight of a styrene/isoprenesulfonic acid copolymer was measured by the gel permeation chromatography (GPC) under the following conditions.

(GPC Conditions)

Guard column: TSK guard column a (manufactured by TOSOH CORPORATION)

Column: TSKgel α-M+TSKgel α-M (manufactured by TOSOH CORPORATION)

Flow rate: 1.0 ml/min

Temperature: 40° C.

Sample concentration: 3 mg/ml

Detector: RI

Reference material: polystyrene

TABLE 1
Anionic water-soluble polymer

| Type | Component | Manufacturer |
|---|---|---|
| I | Acrylic acid/2-acrylamide-2-methylpropanesulfonic acid copolymer | TOAGOSEI |
| | Na (90/10 mol %) | |
| II | Polyacrylic acid Na | NIPPON |
| | | SHOKUBAI |
| III | Polyacrylic acid Na | Kao |
| IV | Methylnaphthalenesulfonic acid formalin condensate Na (Demol | Kao |
| | MS-40) | |
| V | Butylnaphthalenesulfonic acid formalin condensate Na (Demol | Kao |
| | SNB-L) | |
| VI | Naphthalenesulfonic acid formalin condensate Na (Demol RNL) | Kao |
| VII | Styrene/isoprenesulfonic acid Na (44/56 mol %) | JSR |

[Polishing]

Using the above polishing compositions of Examples 1-1 to 1-16 and Comparative Examples 1-1 to 1-14, a substrate to be polished (as described below) was polished under the following polishing conditions. Subsequently, scratches and surface roughness of the polished substrate were measured under the following conditions and evaluated. Table 2 shows the results. After polishing four substrates for each of Examples and Comparative Examples, both surfaces of the individual substrates were measured, and the average of the measured values of the four substrates (i.e., a total of eight surfaces, including upper and lower surfaces) was calculated. Accordingly, the data shown in Table 2 are the resultant averages. The measuring methods of scratches, surface roughness, and a polishing rate shown in Table 2 are also described in the following.

[Substrate to be Polished]

As the substrate to be polished, a Ni—P plated aluminum alloy substrate was polished roughly with a polishing composition including an alumina abrasive beforehand. This substrate had a thickness of 1.27 mm, an outer diameter of 95 mm, an inner diameter of 25 mm, and a center line average roughness Ra of 1 nm, which was measured with an AFM (Digital Instrument NanoScope IIIa Multi Mode AFM). Moreover, the amplitude of long-wavelength waviness (wavelength: 0.4 to 2 mm) was 2 nm, and the amplitude of short-wavelength waviness (wavelength: 50 to 400 μm) was 2 nm.

[Polishing Conditions]

Polishing test machine: “9B Double Side Polisher” manufactured by Speedfam Co., Ltd.

Polishing pad: suede type (thickness: 0.9 mm, average pore diameter: 30 μm) manufactured by FUJIBO HOLDINGS, INC.

Supply of polishing composition: 100 mL/min (supply rate per 1 cm² of a substrate to be polished: 0.072 mL/min)

Number of revolutions of lower surface plate: 32.5 rpm

Polishing pressure: 7.9 kPa

Polishing time: 4 minutes

[Measuring Method of Scratches]

Measuring device: OSA6100 manufactured by Candela Instruments, Inc.

Evaluation: Four substrates were randomly selected from the substrates placed in the polishing test machine, and scratches were measured by irradiating each of the four substrates with a laser at 10000 rpm. Then, the total number of scratches on both surfaces of the four substrates was divided by 8, yielding the number of scratches per substrate surface.

[Measuring Method of Surface Roughness]

An AFM (Digital Instrument NanoScope IIIa Multi Mode AFM) was used to measure points on both sides of each substrate that were located in the middle portion between the inner and outer circumferences, thereby determining the center line average roughness AFM-Ra and the maximum height AFM-Rmax. The average of the measured values of four substrates (i.e., a total of eight surfaces, including upper and lower surfaces) was calculated for AFM-Ra and AFM-Rmax, and the resultant averages of AFM-Ra and AFM-Rmax are shown in Table 2.

(AFM Measurement Conditions)

Mode: Tapping mode

Area: 1×1 μm

Scan rate: 1.0 Hz

Cantilever: NCH-10V

Line: 512×512

[Measuring Method of Polishing Rate]

The weights of each substrate before and after polishing were measured with a gravimeter (“BP-210S” manufactured by Sartorius Ltd.), and a change in weight of each substrate was determined. Then, the average of the weight changes of 10 substrates was obtained as a weight decrement, and the weight decrement was divided by the polishing time to give a weight decreasing rate. This weight decreasing rate was substituted in the following equation and thus converted to a polishing rate (μm/min).

Polishing rate (μm/min)=weight decreasing rate (g/min)/area of one side of a substrate (mm²)/Ni—P plating density (g/cm³)×10⁶

(where the area of one side of the substrate was 6597 mm² and the Ni—P plating density was 7.99 g/cm³)

TABLE 2

| | | Polishing composition | | | | | | | | | | | |
|---|---|---|---|---|---|---|---|---|---|---|---|---|---|
| | | | | | | | Water-soluble | | | | | | |
| | | Colloidal silica | | | | | polymer | | | | | | |
| | | | Average | | | | | Weight | | Polishing evaluation result | | | |
| | | | particle | | | | | average | | Scratch | Polishing | AFM- | AFM- |
| | | | size | CV90 | ΔCV | Content | | molecular | Content | (number/ | rate | Ra | Rmax |
| | | Type | (nm) | (%) | (%) | wt % | Type | weight | wt % | surface) | (μm/min) | (nm) | (nm) |
| Example | 1-1 | A | 35 | 21 | 4.5 | 5.0 | I | 2000 | 0.05 | 45 | 0.07 | 0.12 | 1.7 |
| | 1-2 | B | 37 | 22 | 9.2 | 5.0 | I | 2000 | 0.05 | 74 | 0.08 | 0.12 | 1.8 |
| | 1-3 | C | 36 | 25 | 5.5 | 5.0 | I | 2000 | 0.05 | 53 | 0.08 | 0.13 | 1.8 |
| | 1-4 | D | 37 | 24 | 2.5 | 5.0 | I | 2000 | 0.05 | 36 | 0.07 | 0.12 | 1.7 |
| | 1-5 | D | 37 | 24 | 2.5 | 5.0 | I | 2000 | 0.025 | 41 | 0.08 | 0.11 | 1.6 |
| | 1-6 | D | 37 | 24 | 2.5 | 5.0 | I | 2000 | 0.1 | 38 | 0.09 | 0.12 | 1.7 |
| | 1-7 | E | 27 | 32 | 4.1 | 5.0 | I | 2000 | 0.05 | 32 | 0.09 | 0.09 | 1.4 |
| | 1-8 | E | 27 | 32 | 4.1 | 5.0 | II | 2000 | 0.05 | 30 | 0.08 | 0.09 | 1.4 |
| | 1-9 | E | 27 | 32 | 4.1 | 5.0 | III | 8000 | 0.05 | 40 | 0.08 | 0.09 | 1.4 |
| | 1-10 | F | 20 | 35 | 2.0 | 5.0 | I | 2000 | 0.05 | 42 | 0.06 | 0.09 | 1.4 |
| | 1-11 | E | 27 | 32 | 4.1 | 5.0 | IV | — | 0.05 | 21 | 0.08 | 0.09 | 1.4 |
| | 1-12 | E | 27 | 32 | 4.1 | 5.0 | V | — | 0.05 | 23 | 0.08 | 0.09 | 1.4 |
| | 1-13 | E | 27 | 32 | 4.1 | 5.0 | VI | — | 0.05 | 23 | 0.08 | 0.09 | 1.4 |
| | 1-14 | E | 27 | 32 | 4.1 | 5.0 | VII | 3000 | 0.05 | 16 | 0.08 | 0.09 | 1.4 |
| | 1-15 | A | 35 | 21 | 4.5 | 5.0 | — | — | — | 120 | 0.07 | 0.12 | 1.9 |
| | 1-16 | L | 36 | 19 | 5.1 | 5.0 | — | — | — | 110 | 0.08 | 0.12 | 2.1 |
| Comparative | 1-1 | G | 35 | 21 | 14.0 | 5.0 | — | — | — | 250 | 0.08 | 0.12 | 2.1 |
| Example | 1-2 | G | 35 | 21 | 14.0 | 5.0 | I | 2000 | 0.05 | 206 | 0.07 | 0.12 | 1.8 |
| | 1-3 | H | 32 | 37 | 9.5 | 5.0 | I | 2000 | 0.05 | 265 | 0.11 | 0.16 | 2.5 |
| | 1-4 | I | 85 | 38 | 2.4 | 5.0 | — | — | — | 206 | 0.13 | 0.28 | 4.1 |
| | 1-5 | J | 41 | 25 | 4.8 | 5.0 | — | — | — | 242 | 0.09 | 0.16 | 2.6 |
| | 1-6 | K | 37 | 18 | 15.5 | 5.0 | — | — | — | 221 | 0.09 | 0.12 | 2.1 |
| | 1-7 | M | 26 | 27 | 13.1 | 5.0 | — | — | — | 264 | 0.09 | 0.09 | 1.9 |
| | 1-8 | N | 20 | 35 | 15.2 | 5.0 | — | — | — | 211 | 0.09 | 0.08 | 2.0 |
| | 1-9 | O | 21 | 35 | 11.6 | 5.0 | — | — | — | 688 | 0.11 | 0.11 | 2.0 |
| | 1-10 | P | 26 | 30 | 14.4 | 5.0 | — | — | — | 333 | 0.08 | 0.13 | 2.1 |
| | 1-11 | Q | 40 | 18 | 10.5 | 5.0 | — | — | — | 210 | 0.07 | 0.18 | 2.5 |
| | 1-12 | R | 41 | 34 | 7.5 | 5.0 | — | — | — | 789 | 0.05 | 0.13 | 2.0 |
| | 1-13 | S | 88 | 46 | 1.2 | 5.0 | — | — | — | 210 | 0.14 | 0.29 | 4.5 |
| | 1-14 | T | 101 | 38 | 5.8 | 5.0 | III | 8000 | 0.05 | 158 | 0.13 | 0.31 | 3.4 |

As shown in Table 2, the polishing compositions of Examples 1-1 to 1-16 reduced scratches and the surface roughness (particularly AFM-Rmax) of the polished substrates without reducing the polishing rate, compared to those of Comparative Examples 1-1 to 1-14. Moreover, comparing Examples 1-1 to 1-14 and Examples 1-15 and 1-16 shows that scratches and the surface roughness were further reduced by the addition of the water-soluble polymer.

### Examples 2-1 to 2-13, Comparative Examples 2-1 to 2-10

Polishing compositions were prepared using colloidal silica and the anionic water-soluble polymers shown in Table 3. Then, substrates to be polished were polished with the polishing compositions, and scratches and surface roughness of each of the polished substrates and a polishing rate were evaluated. Table 4 shows the evaluation results. The preparation method of the polishing compositions, the measuring method of each parameter, the polishing conditions (polishing method), and the evaluation method were as follows.

[Preparation Method of Polishing Composition]

The colloidal silica (ID in Table 4: a1-a3, b, c1-c2, d, e, f1-f2, and g-1 manufactured by JGC Catalysts and Chemicals Ltd.), a sulfuric acid (manufactured by Wako Pure Chemical Industries, Ltd.), 1-hydroxyethylidene-1,1-diphosphonic acid (HEDP manufactured by Solutia Japan Limited), a hydrogen peroxide solution (manufactured by Adeka Corporation), and optionally the anionic water-soluble polymers A-C shown in Table 3 were added to ion-exchanged water and mixed to prepare the polishing compositions of Examples 2-1 to 2-13 and Comparative Examples 2-1 to 2-10, as shown in Table 4. The contents of the colloidal silica, the anionic water-soluble polymer, the sulfuric acid, the HEDP, and the hydrogen peroxide in the polishing compositions were 5 wt %, 0.05 wt % (if added), 0.5 wt %, 0.1 wt %, and 0.5 wt %, respectively. The colloidal silica a1-a3 are the same in SA1, SA2, surface roughness, and sphericity, but different in ΔCV value. This is true for the colloidal silica c1-c2 and f1-f2.

TABLE 3
Polymer

| Type | Composition | Molecular weight (Mw) |
|---|---|---|
| A | Acrylic acid Na/AMPS copolymer | 2000 |
| | (weight ratio: 80/20, TOAGOSEI) | |
| B | Acrylic acid Na/AMPS copolymer | 6000 |
| | (weight ratio: 90/10, TOAGOSEI) | |
| C | Polyacrylic acid Na (TOAGOSEI) | 7000 |

[Measuring Method of Sphericity of Colloidal Silica]

A sample including the colloidal silica was observed with a transmission electron microscope (TEM) “JEM-2000FX” (trade name, 80kV, 10000-50000X, manufactured by JEOL Ltd.) in accordance with the manufacturer's instruction manual, and TEM images were photographed. These pictures were scanned into a personal computer as image data using a scanner. Then, a projected area (A1) of a particle and an area (A2) of a circle having a circumference that is the same as the perimeter of the particle were measured with analysis software “WinROOF Ver 3.6” (available from Mitani Corporation). The ratio (A1/A2) of the projected area (A1) of the particle to the area (A2) obtained from the perimeter of the particle was calculated as sphericity. Each of the numerical values in Table 4 is the average of the sphericity of 100 silica particles.

[Measuring Method of Surface Roughness of Colloidal Silica]

As described below, a specific surface area (SA1) was measured by a sodium titration method, and a specific surface area (SA2) was converted from an average particle size (S2) measured by transmission electron microscope observation. The SA1/SA2 ratio was calculated as surface roughness.

<Method for Determining Specific Surface Area (SA1) of Colloidal Silica by Sodium Titration Method>

1) A sample including colloidal silica in an amount corresponding to 1.5 g of SiO₂ was put in a beaker, and the beaker was moved to a thermostatic reaction vessel (25° C.), where pure water was added to the sample until the amount of liquid reached 90 ml. The following operations were performed in the thermostatic reaction vessel at 25° C.

2) A0.1 mol/L hydrochloric acid solution was added so as to adjust the pH in the range of 3.6 to 3.7.

3) After 30 g of sodium chloride was added, the sample was diluted with pure water to 150 ml and stirred for 10 minutes.

4) A pH electrode was set, and a 0.1 mol/L sodium hydroxide solution was dropped into the sample while stirring, thereby adjusting the pH to 4.0.

5) The sample having an adjusted pH of 4.0 was titrated with a 0.1 mol/L sodium hydroxide solution. Then, the amount of the 0.1 mol/L sodium hydroxide solution used for titration and the pH value were recorded at four or more points in a pH range of 8.7 to 9.3. The four or more points were plotted to form a calibration curve with the titration amount on the X axis and the corresponding pH value on the Y axis.

6) The amount of consumption V (ml) of the 0.1 mol/L sodium hydroxide solution per 1.5 g of SiO₂ that was required to raise the pH from 4.0 to 9.0 was calculated by the following equation (1), and the specific surface area SA1 (m²/g) was determined in the following steps [a] to [b].

[a] A value of SA1 was calculated by the following equation (2). If the value was 80 to 350 m²/g, then it was defined as SA1.

[b] If the value was more than 350 m²/g, then a value of SA1 was recalculated by the following equation (3), and this value was defined as SA1.

V=(A×f×100×1.5)/(W×C) (1)

SA1=29.0V−28 (2)

SA1=31.8V−28 (3)

The symbols in the equation (1) represent as follows.

A: amount (ml) of the 0.1 mol/L sodium hydroxide solution per 1.5 g of SiO₂ required to raise the pH from 4.0 to 9.0

f: titer of the 0.1 mol/L sodium hydroxide solution

C: SiO₂ concentration (%) of the sample

W: amount (g) of the sample

<Method for Determining Average Particle Size (S2) and Specific Surface Area (SA2) by Transmission Electron Microscope Observation>

A sample including the colloidal silica was observed with a transmission electron microscope (TEM) “JEM-2000FX” (trade name, 80kV, 10000-50000X, manufactured by JEOL Ltd.) in accordance with the manufacturer's instruction manual, and TEM images were photographed. These pictures were scanned into a personal computer as image data using a scanner. Then, the diameter of a circle having the same area as the projected area of each silica particle was determined with analysis software “WinROOF Ver 3.6” (available from Mitani Corporation) and identified as a particle size. In this manner, the particles sizes of 1000 or more silica particles were obtained. Subsequently, the average of those particle sizes was calculated and defined as an average particle size (S2) measured by transmission electron microscope observation. Next, the average particle size (S2) was substituted in the following equation (4) to determine the specific surface area (SA2).

SA2=6000/(S2ρ) (4)

(ρ: density of the sample)

ρ: 2.2 (for colloidal silica)

[Measuring Method of Average Particle Size, CV Value, and ΔCV Value Based on Scattering Intensity Distribution of Dynamic Light Scattering Method]

The average particle size, the CV value, and the ΔCV value of the colloidal silica were measured in the same manner as Examples 1-1 to 1-16 and Comparative Examples 1-1 to 1-14.

[Polishing]

Using the above polishing compositions of Examples 2-1 to 2-13 and Comparative Examples 2-1 to 2-10, a substrate to be polished (as described below) was polished under the following polishing conditions. Subsequently, scratches and surface roughness of the polished substrate were measured under the following conditions and evaluated. Table 4 shows the results. After polishing four substrates for each of Examples and Comparative Examples, both surfaces of the individual substrates were measured, and the average of the measured values of the four substrates (i.e., a total of eight surfaces, including upper and lower surfaces) was calculated. Accordingly, the data shown in Table 4 are the resultant averages. The measuring methods of scratches, surface roughness, and a polishing rate shown in Table 4 are also described in the following.

[Substrate to be Polished]

The substrate to be polished was the same as that used in Examples 1-1 to 1-16 and Comparative Examples 1-1 to 1-14, i.e., a Ni—P plated aluminum alloy substrate that was polished roughly with a polishing composition including an alumina abrasive beforehand.

[Polishing Conditions]

Polishing test machine: “9B Double Side Polisher” manufactured by Speedfam Co., Ltd.

Polishing pad: suede type (thickness: 0.9 mm, average pore diameter: 30 μm) manufactured by FUJIBO HOLDINGS, INC.

Supply of polishing composition: 100 mL/min (supply rate per 1 cm² of a substrate to be polished: 0.072 mL/min)

Number of revolutions of lower surface plate: 32.5 rpm

Polishing pressure: 7.9 kPa

Polishing time: 8 minutes

[Measuring Method of Scratches]

Measuring device: Candela OSA6100 manufactured by KLA-Tencor Corporation

Evaluation: Four substrates were randomly selected from the substrates placed in the polishing test machine, and scratches were measured by irradiating each of the four substrates with a laser at 10000 rpm. Then, the total number of scratches on both surfaces of the four substrates was divided by 8, yielding the number of scratches per substrate surface. In Table 4, the results were shown as relative values with respect to 100 of Comparative Example 2-1. In Comparative Examples 2-7 to 2-9, the number of scratches exceeded the upper limit of the measurement and therefore could not be measured.

[Measuring Method of Surface Roughness and Polishing Rate]

The surface roughness and the polishing rate were measured in the same manner as Examples 1-1 to 1-16 and Comparative Examples 1-1 to 1-14. Table 4 shows the results.

TABLE 4

| | | Colloidal silica | | | | | | | | |
|---|---|---|---|---|---|---|---|---|---|---|
| | | | Sodium | | | | | | | |
| | | | titration | TEM | | | | Dynamic light scattering (DLS) | | |
| | | | Specific | Average | Specific | | | Average | | |
| | | | surface | particle | surface | Surface | | particle | | |
| | | | area SA1 | size S2 | area SA2 | roughness | | size | CV90 | ΔCV |
| | | ID | (m2/g) | (nm) | (m2/g) | SA1/SA2 | Sphericity | (nm) | (%) | (%) |
| Example | 2-1 | a1 | 262 | 21 | 130 | 2.02 | 0.78 | 28 | 27 | 1.7 |
| | 2-2 | a1 | 262 | 21 | 130 | 2.02 | 0.78 | 28 | 27 | 1.7 |
| | 2-3 | c1 | 165 | 23 | 119 | 1.39 | 0.80 | 28 | 24 | 4.7 |
| | 2-4 | d | 181 | 23 | 119 | 1.53 | 0.80 | 28 | 19 | 4.5 |
| | 2-5 | d | 181 | 23 | 119 | 1.53 | 0.80 | 28 | 19 | 4.5 |
| | 2-6 | d | 181 | 23 | 119 | 1.53 | 0.80 | 28 | 19 | 4.5 |
| | 2-7 | d | 181 | 23 | 119 | 1.53 | 0.80 | 28 | 19 | 4.5 |
| | 2-8 | e | 208 | 22 | 124 | 1.68 | 0.79 | 31 | 28 | 4.1 |
| | 2-9 | f1 | 176 | 35 | 78 | 2.26 | 0.82 | 39 | 26 | 3.7 |
| | 2-10 | f1 | 176 | 35 | 78 | 2.26 | 0.82 | 39 | 26 | 3.7 |
| | 2-11 | h | 118 | 33 | 83 | 1.43 | 0.84 | 40 | 34 | 5.2 |
| | 2-12 | h | 118 | 33 | 83 | 1.43 | 0.84 | 40 | 34 | 5.2 |
| | 2-13 | h | 118 | 33 | 83 | 1.43 | 0.84 | 40 | 34 | 5.2 |
| Comparative | 2-1 | a2 | 262 | 21 | 130 | 2.02 | 0.78 | 28 | 27 | 11.1 |
| Example | 2-2 | a3 | 262 | 21 | 130 | 2.02 | 0.78 | 28 | 27 | 17.9 |
| | 2-3 | b | 154 | 23 | 119 | 1.30 | 0.80 | 26 | 27 | 13.1 |
| | 2-4 | c2 | 165 | 23 | 119 | 1.39 | 0.80 | 28 | 24 | 10.8 |
| | 2-5 | f2 | 176 | 35 | 78 | 2.26 | 0.82 | 39 | 26 | 14.3 |
| | 2-6 | g | 98 | 32 | 85 | 1.15 | 0.85 | 37 | 27 | 15.5 |
| | 2-7 | i | 194 | 20 | 136 | 1.42 | 0.60 | 66 | 35 | 1.5 |
| | 2-8 | j | 184 | 21 | 130 | 1.42 | 0.66 | 55 | 39 | 9.3 |
| | 2-9 | k | 175 | 22 | 124 | 1.41 | 0.71 | 66 | 41 | 8.8 |
| | 2-10 | l | 160 | 22 | 124 | 1.29 | 0.74 | 65 | 39 | 7.2 |

| | | | | | Polishing properties | | | |
|---|---|---|---|---|---|---|---|---|
| | | Anionic water-soluble polymer | | | | Surface | | |
| | | | Added | Molecular | Polishing | roughness | | |
| | | | amount | weight | rate | Ra | R-Max | Scratch |
| | | ID | (wt %) | (Mw) | (um/min) | (A) | (nm) | (relative value) |
| Example | 2-1 | — | — | — | 0.12 | 0.10 | 1.7 | 48 |
| | 2-2 | A | 0.05 | 2000 | 0.11 | 0.10 | 1.6 | 30 |
| | 2-3 | A | 0.05 | 2000 | 0.09 | 0.09 | 1.6 | 26 |
| | 2-4 | — | — | — | 0.10 | 0.09 | 1.5 | 40 |
| | 2-5 | A | 0.05 | 2000 | 0.10 | 0.09 | 1.4 | 24 |
| | 2-6 | B | 0.05 | 6000 | 0.10 | 0.09 | 1.4 | 19 |
| | 2-7 | C | 0.05 | 7000 | 0.10 | 0.09 | 1.4 | 20 |
| | 2-8 | A | 0.05 | 2000 | 0.11 | 0.10 | 1.4 | 21 |
| | 2-9 | — | — | — | 0.13 | 0.12 | 1.8 | 56 |
| | 2-10 | A | 0.05 | 2000 | 0.13 | 0.12 | 1.9 | 29 |
| | 2-11 | A | 0.05 | 2000 | 0.13 | 0.12 | 1.7 | 31 |
| | 2-12 | B | 0.05 | 6000 | 0.13 | 0.12 | 1.7 | 25 |
| | 2-13 | C | 0.05 | 7000 | 0.13 | 0.12 | 1.7 | 24 |
| Comparative | 2-1 | — | — | — | 0.12 | 0.10 | 1.9 | 100 |
| Example | 2-2 | — | — | — | 0.12 | 0.11 | 2.3 | 206 |
| | 2-3 | — | — | — | 0.08 | 0.09 | 2.0 | 104 |
| | 2-4 | — | — | — | 0.11 | 0.09 | 1.9 | 144 |
| | 2-5 | — | — | — | 0.13 | 0.12 | 2.2 | 91 |
| | 2-6 | — | — | — | 0.10 | 0.12 | 2.0 | 87 |
| | 2-7 | — | — | — | 0.13 | 0.15 | 3.2 | — ^{} |
| | 2-8 | — | — | — | 0.12 | 0.14 | 2.8 | — ^{} |
| | 2-9 | — | — | — | 0.12 | 0.14 | 2.9 | — ^{} |
| | 2-10 | — | — | — | 0.12 | 0.14 | 2.7 | 472 |

^{} Unmeasurable value (exceeding the upper limit of measurement)

As shown in Table 4, the polishing compositions of Examples 2-1 to 2-13 reduced scratches and the surface roughness of the polished substrates without reducing the polishing rate, compared to those of Comparative Examples 2-1 to 2-10. Moreover, comparing Examples 2-1, 2-4, and 2-9 and the remaining Examples shows that scratches and the surface roughness were likely to be further reduced by the addition of the water-soluble polymer.

### INDUSTRIAL APPLICABILITY

The present invention can provide, e.g., a magnetic disk substrate suitable for high recording density.

1. A method for preparing a polishing composition for a magnetic disk substrate that includes colloidal silica, comprising;
selecting and/or confirming and then using the colloidal silica, the average particle size of the colloidal silica being 1 to 40 nm, the CV90 of the colloidal silica being 1 to 35%, and ΔCV value of the colloidal silica being 0 to 10%,
wherein the average particle size is measured at a detection angle of 90° according to the dynamic light scattering method, and the CV90 is obtained by dividing a standard deviation measured at the detection angle of 90° according to the dynamic light scattering method by the average particle size and multiplying the result by 100, and the ΔCV value is a difference (ΔCV=CV30−CV90) between a value (CV30) obtained by dividing a standard deviation based on a scattering intensity distribution at a detection angle of 30° according to a dynamic light scattering method by an average particle size based on the scattering intensity distribution and multiplying the result by 100 and the CV90.

2. The method according to claim 1, wherein using the colloidal silica comprising; mixing water and the colloidal silica.

3. The method according to claim 2, further comprising; mixing an anionic water-soluble polymer with water and the colloidal silica.

4. A method for manufacturing a magnetic disk substrate comprising:
selecting and/or confirming and then using a polishing composition that includes colloidal silica, the average particle size of the colloidal silica being 1 to 40 nm, the CV90 of the colloidal silica being 1 to 35%, and ΔCV value of the colloidal silica being 0 to 10%, wherein the average particle size is measured at a detection angle of 90° according to the dynamic light scattering method, and the CV90 is obtained by dividing a standard deviation measured at the detection angle of 90° according to the dynamic light scattering method by the average particle size and multiplying the result by 100, and the ΔCV value is a difference (ΔCV=CV30−CV90) between a value (CV30) obtained by dividing a standard deviation based on a scattering intensity distribution at a detection angle of 30° according to a dynamic light scattering method by an average particle size based on the scattering intensity distribution and multiplying the result by 100 and the CV90, and
polishing a substrate to be polished with the polishing composition.

5. The method according to claim 4, wherein the substrate is a Ni—P plated aluminum alloy substrate.

6. A method for manufacturing a magnetic disk substrate comprising:
preparing a polishing composition by a method according to claim 1, and
polishing a substrate to be polished with the polishing composition.

7. The method according to claim 6, wherein the substrate is a Ni—P plated aluminum alloy substrate.
